(19) United States
(12) Patent Application Publication
(10) Pub. No.: US 2006/0238944 A1
(43) Pub. Date: Oct. 26, 2006

(54) Regulator

(75) Inventor: Shinzo Yamamoto, Osaka (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/407,250

(22) Filed: Apr. 20, 2006

(30) Foreign Application Priority Data
Apr. 26, 2005 (JP) 2005-127716

(51) Int. Cl. H02H 9/02

(52) U.S. Cl. 361/93.1

(57) ABSTRACT

A regulator of the present invention includes a leadframe having a terminal portion for current supply, an IC chip having a pad for current supply, and a wire for current supply that electrically connects the terminal portion for current supply and the pad for current supply. Inside the IC chip, there is provided an overcurrent detection portion (for example, a comparator) that detects an overcurrent based on a difference in voltage across the wire for current supply. This makes it possible to make the regulator compact and improve the accuracy in detecting an overcurrent.

This nonprovisional application claims priority under 35 U.S.C. § 119(a) on Patent Application No. 2005-127716 filed in Japan on Apr. 26, 2005, the entire contents of which are hereby incorporated by reference.

### BACKGROUND OF THE INVENTION

1. Field of the Invention

The present invention relates to a regulator that stabilizes a voltage.

2. Description of Related Art

A series regulator shown in FIG. 8 will be described as an example of a conventional regulator. The regulator shown in FIG. 8 includes a power transistor Q1, resistances R1 and R2, and a control IC 100′. The power transistor Q1 is a power transistor (hereinafter also referred to as an output transistor) that is provided between a current injection line into which current is injected from an input power source and a current supply line that supplies a load with current. The control IC 100′ includes a reference voltage generation circuit 1, an error amplifier 2, a protection circuit 3′, and an ON/OFF control circuit 4, and uses an input voltage Vin as its drive voltage.

The regulator shown in FIG. 8 is a device that stabilizes an output voltage Vo by controlling a base current of the power transistor Q1 with the control IC 100′ and adjusting the output voltage Vo to a value that has been set in advance in accordance with requirements of a load. Specifically, the series regulator shown in FIG. 8 stabilizes the output voltage Vo as follows. An error between a reference voltage Vref outputted from the reference voltage generation circuit 1 and an adjusting voltage Vadj obtained by dividing the output voltage Vo with the resistances R1 and R2 is amplified by the error amplifier 2, and a collector current of the power transistor Q1 is controlled by adjusting the base current of the power transistor Q1 in accordance with the output of the error amplifier 2. Although the regulator shown in FIG. 8 uses a bipolar transistor as the output transistor, it is in practice also possible to use, instead of the bipolar transistor, a MOS transistor (for example, a CMOS transistor). When the MOS transistor is used as the output transistor, the regulator stabilizes the output voltage Vo by controlling a drain current of the output transistor, namely, the MOS transistor by adjusting a gate voltage thereof in accordance with the output of the error amplifier 2.

Incidentally, the regulator is in general built as a resin-sealed module in which an IC chip is bonded to a leadframe with epoxy adhesive, silver paste, or soldering paste, for example, and the lead terminals of the leadframe are connected to the pads of the IC chip by using a wire such as a gold wire or an aluminum wire for electrical conduction therebetween.

In general, the regulator has inside the IC chip a circuit for achieving an additional function. The IC chip usually has a protection circuit such as an overcurrent protection circuit or an overheating protection circuit. This ensures that the protection circuit protects the regulator against overcurrent or overheating by controlling the output transistor in that event. Some regulators have inside the IC chip an ON/OFF control circuit for controlling ON/OFF of the electric power supply to the error amplifier that amplifies an error between a voltage based on the output voltage and a reference voltage, and thus can control ON/OFF of the electric power supply to a load connected to an output terminal thereof. The regulator shown in FIG. 8 is provided with the protection circuit 3′ and the ON/OFF control circuit 4 as the circuit for achieving an additional function.

When the resistances R1 and R2 are externally attached to the IC chip, the regulator shown in FIG. 8 has the configuration shown in FIG. 9. In FIG. 9, reference character H1 denotes a leadframe header, reference character C1′ denotes an IC chip, reference character B1 denotes a bonding member with which the IC chip C1′ is bonded to the leadframe header H1, reference character S1 denotes sealing resin, reference characters T1 to T6 each denote a leadframe terminal portion, reference characters W1 to W4 and W6 each denote a connecting wire, and reference characters P1 to P4 and P6 each denote a pad provided on the IC chip C1′. The leadframe is built with the leadframe header H1 and the leadframe terminal portions T1 to T6. Though not shown in FIG. 9, the power transistor Q1 and the control IC 100′ are mounted on the IC chip C1′.

The leadframe terminal portion T3 and the leadframe header H1 are integrally formed into a single member. The leadframe terminal portion T1 and the pad P1 are electrically connected to each other by the connecting wire W1. The leadframe terminal portion T2 and the pad P2 are electrically connected to each other by the connecting wire W2. The leadframe terminal portion T3 and the pad P3 are electrically connected to each other by the connecting wire W3. The leadframe terminal portion T4 and the pad P4 are electrically connected to each other by the connecting wire W4. The leadframe terminal portion T6 and the pad P6 are electrically connected to each other by the connecting wire W6. One end of the externally attached resistance R1 is connected to the leadframe terminal portion T2, the other end of the resistance R1 and one end of the externally attached resistance R2 are connected to the leadframe terminal portion T6, and the other end of the resistance R2 is connected to the leadframe terminal portion T3. The input voltage Vin is applied to the leadframe terminal portion T1, a ground voltage GND is applied to the leadframe terminal portion T3, and an ON/OFF control signal SEL is inputted to the leadframe terminal portion T4. When the inputted ON/OFF control signal SEL is a signal for turning on the electric power supply, the output voltage Vo is generated at the leadframe terminal portion T2, and the adjusting voltage Vadj is applied to the leadframe terminal portion T6 in conjunction with the generation of the output voltage Vo.

FIG. 10 shows the configuration including the leadframe terminal portion, the pads, and the connecting wires of the regulator shown in FIG. 8 having the structure shown in FIG. 9. Note that, in FIG. 10, such members as are found also in FIGS. 8 and 9 will be identified with common reference characters, and their explanations will not be repeated.

On the other hand, when the resistances R1 and R2 are built in the IC chip, in consideration of a voltage drop across the connecting wire, it is preferable that a connecting wire for current supply (a connecting wire W2 shown in FIG. 11) and a connecting wire for sensing the output voltage Vo (a connecting wire W5 shown in FIG. 11) be separately provided so as to detect the output voltage Vo in a position closer to the load. When such a configuration is adopted, the regulator shown in FIG. 8 has the configuration shown in FIG. 11. Note that, in FIG. 11, such members as are found also in FIG. 9 will be identified with common reference characters, and their explanations will not be repeated.

The configuration shown in FIG. 11 is a modified version of the configuration shown in FIG. 9 in which the pad P6 of the IC chip C1′ is removed therefrom, a pad P5 is additionally provided thereto, the connecting wire W6 and the externally attached resistances R1 and R2 are removed therefrom, and a connecting wire W5 for sensing is additionally provided thereto. Though not shown in FIG. 11, the resistances R1 and R2, in addition to the power transistor Q1 and the control IC 100′, are mounted on the IC chip C1′.

The leadframe terminal portion T2 and the pad P5 are electrically connected to each other by the connecting wire W5 for sensing. The regulator is so designed as to have the configuration in which the connecting wire for current supply (the connecting wire W2 shown in FIG. 11) and the connecting wire for sensing the output voltage Vo (the connecting wire W5 shown in FIG. 11) are separately provided, making it possible to set a desired voltage with consideration given to the voltage drop across the connecting wire for current supply.

FIG. 12 shows the configuration including the leadframe terminal portion, the pads, and the connecting wires of the regulator shown in FIG. 8 having the structure shown in FIG. 11. Note that, in FIG. 12, such members as are found also in FIGS. 8 and 11 will be identified with common reference characters, and their explanations will not be repeated.

There are two main types of overcurrent protection method: one of which is a method that monitors a voltage across an overcurrent detecting resistance that is added in series with an input or output side of an output transistor and, when the voltage across the overcurrent detecting resistance becomes equal to or higher than a predetermined value, limits a base current of the output transistor; the other of which is, when the output transistor is a bipolar transistor, for example, a method that monitors a base current of the output transistor and, when the base current increases, limits the base current.

When the former method is adopted and an overcurrent detecting resistance is provided inside an IC chip (see FIGS. 9 and 10 of JP-A-2004-242446), the area of the IC chip inconveniently increases. On the other hand, when the former method is adopted and an overcurrent detecting resistance is externally attached to an IC chip (see FIGS. 1 and 2 of JP-A-2004-242446) the size of a regulator inconveniently increases due to the overcurrent detecting resistance externally attached to the IC chip. As just described, the overcurrent detecting resistance hampers miniaturization of the regulator.

When the latter method is adopted, an overcurrent is detected by monitoring a base current of the output transistor. This undesirably results in variations in an overcurrent detecting point due to variations in h_{fe} (the current gain in the common-emitter configuration with the output short-circuited).

In addition to the above-described two overcurrent protection methods, an overcurrent protection method that uses a fuse is widely used. Specifically, when current more than a fuse is rated at flows therethrough, the metal wire inside the fuse melts and thus stops conducting. By applying to this overcurrent protection method a method that makes the wire inside the regulator serve as an equivalent of the fuse (see JP-U-S60-158214), it becomes possible to stop conducting by melting the wire inside the regulator when an overcurrent flows through the wire inside the regulator. However, what is done here is simply to select a wire having a fusing current that provides an adequate margin with respect to an actually used current value; that is, conventionally, no such overcurrent detection method has been practiced as detects an overcurrent by detecting whether or not the wire has melted.

### SUMMARY OF THE INVENTION

An object of the present invention is to provide a regulator that can be made compact and has a high degree of accuracy in detecting an overcurrent.

To achieve the above object, according to one aspect of the present invention, a regulator has the following configuration (hereinafter referred as a first configuration) The regulator includes a leadframe, an IC chip, a wire for current supply, and an overcurrent detection portion that detects an overcurrent based on a difference in voltage across the wire for current supply. The leadframe is provided with a terminal portion for current supply that is part of a current supply line that supplies a load with current. The IC chip is provided with a pad for current supply that is part of the current supply line. The wire for current supply is part of the current supply line and electrically connects the terminal portion for current supply and the pad for current supply.

With this configuration, it is possible to detect an overcurrent without providing an overcurrent detecting resistance, making it possible to make the regulator compact. Moreover, this provides a higher degree of accuracy in detecting an overcurrent compared to a method of detecting an overcurrent by monitoring a base current of an output transistor. Advisably, the overcurrent detection portion is provided inside the IC chip.

To achieve the above object, according to another aspect of the present invention, a regulator includes a leadframe, an IC chip, a wire for current injection, and an overcurrent detection portion that detects an overcurrent based on a difference in voltage across the wire for current injection. The leadframe is provided with a terminal portion for current injection that is part of a current injection line into which current is injected from an input power source. The IC chip is provided with a pad for current injection that is part of the current injection line. The wire for current injection is part of the current injection line and electrically connects the terminal portion for current injection and the pad for current injection.

With this configuration, it is possible to detect an overcurrent without providing an overcurrent detecting resistance, making it possible to make the regulator compact. Moreover, this provides a higher degree of accuracy in detecting an overcurrent compared to a method of detecting an overcurrent by monitoring a base current of an output transistor. Advisably, the overcurrent detection portion is provided inside the IC chip.

Preferably, the regulator configured as described above includes a voltage conversion portion that converts an input voltage to an output voltage and a control portion that controls the voltage conversion portion in accordance with the output voltage, and overcurrent protection is performed by limiting, when an overcurrent is detected by the overcurrent detection portion, a control signal to be outputted from the control portion to the voltage conversion portion. Preferably, the regulator configured as described above includes a voltage conversion portion that converts an input voltage to an output voltage and a control portion that controls the voltage conversion portion in accordance with the output voltage, and overcurrent protection is performed by stopping, when an overcurrent is detected by the overcurrent detection portion, electric power supply to the control portion. From the viewpoint of making the regulator compact, it is preferable that the entire portion of the voltage conversion portion and the control portion be provided inside the IC chip. In practice, however, part of the voltage conversion portion and the control portion may be externally attached to the IC chip.

Preferably, in the regulator with the first configuration, the overcurrent detection portion judges that an overcurrent occurs when a difference in voltage across the wire for current supply is substantially equal to a difference between input and output voltages of the regulator. With this configuration, it is judged that an overcurrent occurs when the wire for current supply melts. The regulator with this configuration not only makes the wire for current supply serve as a fuse, but also adopts an overcurrent detecting method that detects an overcurrent by detecting whether or not the wire for current supply has melted. Advisably, in the regulator with this configuration, the leadframe is provided with a terminal portion for current injection that is part of a current injection line into which current is injected from an input power source, the IC chip is provided with a pad for current injection that is part of the current injection line, the regulator further comprises a wire for current injection that is part of the current injection line and electrically connects the terminal portion for current injection and the pad for current injection, and the minimum fusing current of the wire for current supply is smaller than the minimum fusing current of the wire for current injection. This prevents overcurrent detection from becoming impossible when the wire for current injection melts earlier than the wire for current supply.

To achieve the above object, according to another aspect of the present invention, a regulator has a plurality of output lines and includes a leadframe, an IC chip, wires for current supply provided one for each of the output lines, a wire for current injection, a first overcurrent detection portion provided one for each of at least one output line, and a second overcurrent detection portion that detects an overcurrent based on a difference in voltage across the wire for current injection. The leadframe is provided with terminal portions for current supply one for each of the output lines, the terminal portion for current supply being part of a current supply line that supplies a load with current, and is provided with a terminal portion for current injection that is part of a current injection line into which current is injected from an input power source. The IC chip is provided with pads for current supply one for each of the output lines, the pad for current supply being part of the current supply line, and is provided with a pad for current injection that is part of the current injection line. The wire for current supply is part of the current supply line and electrically connects the terminal portion for current supply and the pad for current supply. The wire for current injection is part of the current injection line and electrically connects the terminal portion for current injection and the pad for current injection. The first overcurrent detection portion detects an overcurrent based on a difference in voltage across the wire for current supply.

With this configuration, it is possible to detect an overcurrent without providing an overcurrent detecting resistance, making it possible to make the regulator compact. Moreover, this provides a higher degree of accuracy in detecting an overcurrent compared to a method of detecting an overcurrent by monitoring a base current of an output transistor. Furthermore, by performing overcurrent protection by using the second overcurrent detection portion, it is possible to prevent, if in a plurality of lines the load currents are simultaneously close to overcurrent, current injected from the input power source into the multiple output regulator from becoming so large that the input power source is put under an excessive load. Advisably, the first overcurrent detection portion and the second overcurrent detection portion are provided inside the IC chip.

As a method of adjusting an overcurrent detecting point of the regulator configured as described above and provided with a plurality of the pads for current supply and/or a plurality of the pads for current injection, there is provided a method of adjusting an overcurrent detecting point by adjusting the length of the wire for current supply and/or the wire for current injection by selecting the pad for current supply and/or the pad for current injection. As a method of adjusting an overcurrent detecting point of the regulator configured as described above, there is provided a method of adjusting an overcurrent detecting point by selecting a material of the wire for current supply and/or the wire for current injection. With these methods, it is possible to adjust an overcurrent detecting point of a product during assembly, even using the same IC chip.

### BRIEF DESCRIPTION OF THE DRAWINGS

FIG. 1 is a diagram showing the configuration of the regulator according to a first embodiment of the present invention.

FIG. 2 is a diagram showing the structure of the regulator shown in FIG. 1.

FIG. 3 is a diagram showing the configuration of the regulator according to a second embodiment of the present invention.

FIG. 4 is a diagram showing the structure of the regulator shown in FIG. 3.

FIG. 5 is a diagram showing a modified example of the regulator shown in FIG. 1.

FIG. 6 is a diagram showing an example of the configuration of the multiple output regulator of the present invention.

FIG. 7 is a diagram showing another example of the structure of the regulator shown in FIG. 1.

FIG. 8 is a diagram showing an example of the configuration of a conventional regulator.

FIG. 9 is a diagram showing the structure of the regulator shown in FIG. 8.

FIG. 10 is a diagram showing the configuration including the leadframe terminal portion, the pads, and the connecting wires of the regulator shown in FIG. 8 having the structure shown in FIG. 9.

FIG. 11 is a diagram showing another example of the structure of the regulator shown in FIG. 8.

FIG. 12 is a diagram showing the configuration including the leadframe terminal portion, the pads, and the connecting wires of the regulator shown in FIG. 8 having the structure shown in FIG. 11.

### DETAILED DESCRIPTION OF PREFERRED EMBODIMENTS

Hereinafter, embodiments of the present invention will be described with reference to the accompanying drawings. Here, a series regulator that uses a bipolar transistor as a power transistor, namely, an output transistor provided between a current injection line into which current is injected from an input power source and a current supply line that supplies a load with current will be described as an example of the regulator according to the present invention.

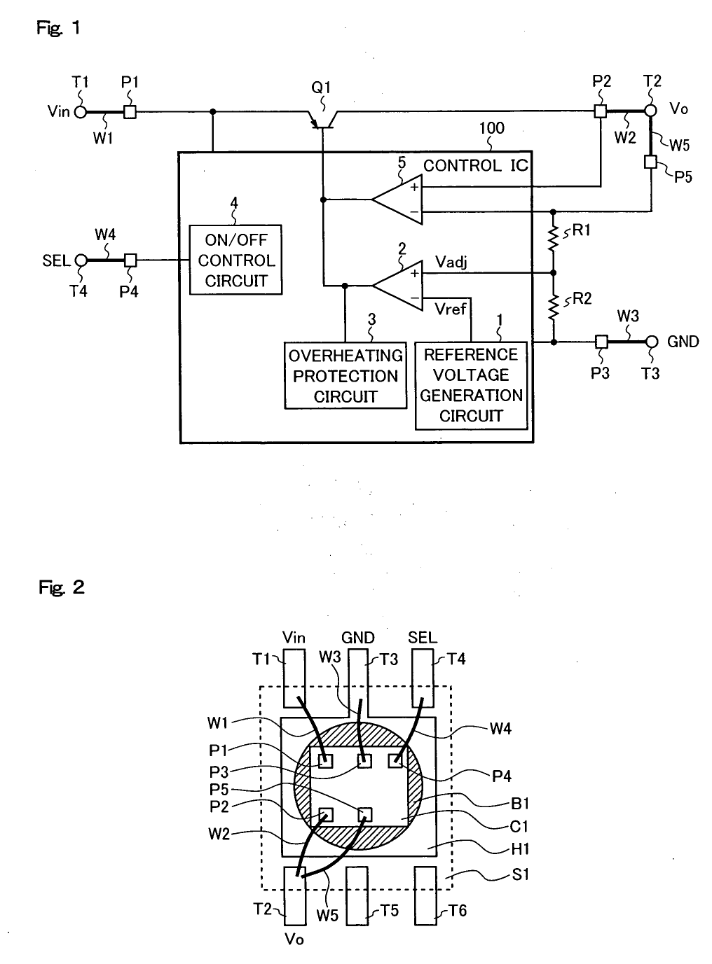

First, a first embodiment of the present invention will be described. The configuration of the series regulator according to the first embodiment of the present invention is shown in FIG. 1, and the structure of the regulator shown in FIG. 1 is shown in FIG. 2. Note that, in FIG. 2, such members as are found also in FIG. 1 will be identified with common reference characters.

The regulator shown in FIG. 1 includes a power transistor Q1, resistances R1 and R2, and a control IC 100. The control IC 100 includes a reference voltage generation circuit 1, an error amplifier 2, an overheating protection circuit 3, an ON/OFF control circuit 4, and a comparator 5, and uses an input voltage Vin as its drive voltage. That part between a leadframe terminal portion T1 to the emitter of a power transistor Q1 forms a current injection line into which current is injected from an input power source (not shown), and that part between the collector of the power transistor Q1 to a leadframe terminal portion T2 forms a current supply line that supplies a load (not shown) with current.

The regulator shown in FIG. 1 is a device that stabilizes an output voltage Vo by controlling a base current of the power transistor Q1 with the control IC 100 and adjusting the output voltage Vo to a value that has been set in advance in accordance with requirements of the load. Specifically, the series regulator shown in FIG. 1 stabilizes the output voltage Vo as follows. An error between a reference voltage Vref outputted from the reference voltage generation circuit 1 and an adjusting voltage Vadj obtained by dividing the output voltage Vo with the resistances R1 and R2 is amplified by the error amplifier 2, and a collector current of the power transistor Q1 is controlled by adjusting the base current of the power transistor Q1 in accordance with the output of the error amplifier 2.

The overheating protection circuit 3 protects the regulator by limiting the base current of the power transistor Q1 when overheating occurs. The ON/OFF control circuit 4 controls ON/OFF of the electric power supply to the error amplifier 2 depending on an ON/OFF control signal SEL. Note that a description of the comparator 5 will be given later.

Next, the structure of the regulator shown in FIG. 1 will be described with reference to FIG. 2. In FIG. 2, reference character H1 denotes a leadframe header, reference character C1 denotes an IC chip, reference character B1 denotes a bonding member with which the IC chip C1 is bonded to the leadframe header H1, reference character S1 denotes sealing resin, reference characters T1 to T6 each denote a leadframe terminal portion, reference characters W1 to W5 each denote a connecting wire, and reference characters P1 to P5 each denote a pad provided on the IC chip C1. The leadframe is built with the leadframe header H1 and the leadframe terminal portions T1 to T6. Though not shown in FIG. 2, the power transistor Q1, the control IC 100, and the resistances R1 and R2 are mounted on the IC chip C1.

The leadframe terminal portion T3 and the leadframe header H1 are integrally formed into a single member. The leadframe terminal portion T1 and the pad P1 are electrically connected to each other by the connecting wire W1. The leadframe terminal portion T2 and the pad P2 are electrically connected to each other by the connecting wire W2. The leadframe terminal portion T3 and the pad P3 are electrically connected to each other by the connecting wire W3. The leadframe terminal portion T4 and the pad P4 are electrically connected to each other by the connecting wire W4. The leadframe terminal portion T2 and the pad P5 are electrically connected to each other by the connecting wire W5. An input voltage Vin is applied to the leadframe terminal portion T1, a ground voltage GND is applied to the leadframe terminal portion T3, and an ON/OFF control signal SEL is inputted to the leadframe terminal portion T4. When the ON/OFF control signal SEL is a signal for turning on the electric power supply, the output voltage Vo is generated at the leadframe terminal portion T2.

Next, the comparator 5 will be described. The non-inverting input terminal of the comparator 5 is connected to the pad P2, the inverting input terminal thereof is connected to the pad P5, and the output terminal thereof is connected to the base of the power transistor Q1. With this configuration, the comparator 5 detects a difference in voltage across the connecting wire W2 through which the output current of the regulator flows, and then performs output in accordance with the difference in voltage across the connecting wire W2. Since practically no current flows therethrough, there is a vanishingly small difference in voltage across the connecting wire W5.

The error amplifier 2, the comparator 5, and the connecting wire W2 are designed so that, when the difference in voltage across the connecting wire W2 becomes a value corresponding to an overcurrent, the output voltage of the comparator 5 becomes higher than the output voltage of the error amplifier 2 and the base current of the power transistor Q1 is limited. This makes it possible to perform overcurrent protection without providing an overcurrent detecting resistance. Furthermore, this provides a higher degree of accuracy in detecting an overcurrent compared to a method of detecting an overcurrent by monitoring the base current of the output transistor.

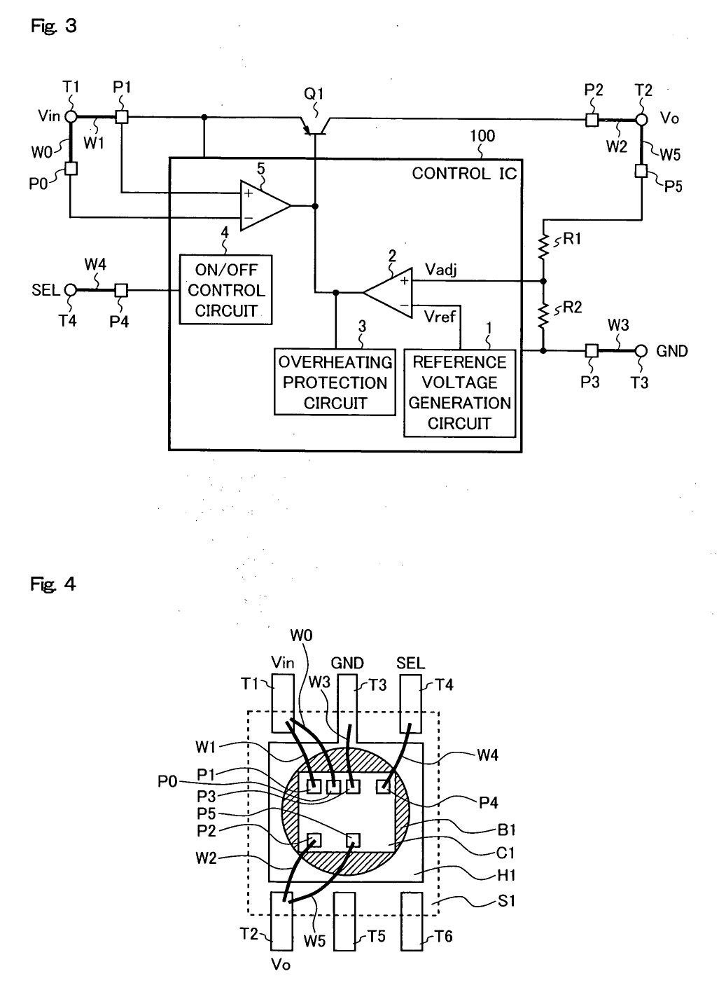

Next, a second embodiment of the present invention will be described. The configuration of the series regulator according to the second embodiment of the present invention is shown in FIG. 3. The structure of the regulator shown in FIG. 3 is shown in FIG. 4. Note that, in FIG. 3, such members as are found also in FIG. 1 will be identified with common reference characters, and their explanations will not be repeated. In FIG. 4, such members as are found also in FIG. 2 will be identified with common reference characters, and their explanations will not be repeated. In FIG. 4, such members as are found also in FIG. 3 will be identified with common reference characters.

The regulator shown in FIG. 3 differs from the regulator shown in FIG. 1 in that the comparator 5 thereof detects, not a difference in voltage across the connecting wire W2 that is a wire for current supply, a difference in voltage across the connecting wire W1 that is a wire for current injection. In the regulator shown in FIG. 3, the non-inverting input terminal of the comparator 5 is connected to the pad P1, the IC chip C1 is provided with an additional pad P0 that is connected to the inverting input terminal of the comparator 5, and the leadframe terminal portion T1 and the pad P0 are electrically connected to each other by a connecting wire W0.

With this configuration, the comparator 5 detects the difference in voltage across the connecting wire W1 through which the input current of the regulator flows, and then performs output in accordance with the difference in voltage across the connecting wire W1. Since practically no current flows therethrough, there is a vanishingly small difference in voltage across the connecting wire W0.

The error amplifier 2, the comparator 5, and the connecting wire W1 are designed so that, when the difference in voltage across the connecting wire W1 becomes a value corresponding to an overcurrent, the output voltage of the comparator 5 becomes higher than the output voltage of the error amplifier 2 and the base current of the power transistor Q1 is limited. This makes it possible to perform overcurrent protection without providing an overcurrent detecting resistance. Furthermore, this provides a higher degree of accuracy in detecting an overcurrent compared to a method of detecting an overcurrent by monitoring the base current of the output transistor.

Whereas the regulator shown in FIG. 1 performs overcurrent protection for the current flowing therefrom toward the load, the regulator shown in FIG. 3, although it needs to be additionally provided with a pad P0 that is a sensing pad for detecting the input voltage Vin, can perform overcurrent protection for the current obtained by adding the current flowing therefrom toward the load and the current consumed by the regulator itself. In the case of a series regulator using a bipolar transistor as the output transistor, the greater the current flowing from the regulator toward the load becomes, the greater the base current of the output transistor becomes, and the greater the current consumed by the regulator itself becomes. Therefore, it is highly useful to perform overcurrent protection for the current obtained by adding the current flowing from the regulator toward the load and the current consumed by the regulator itself.

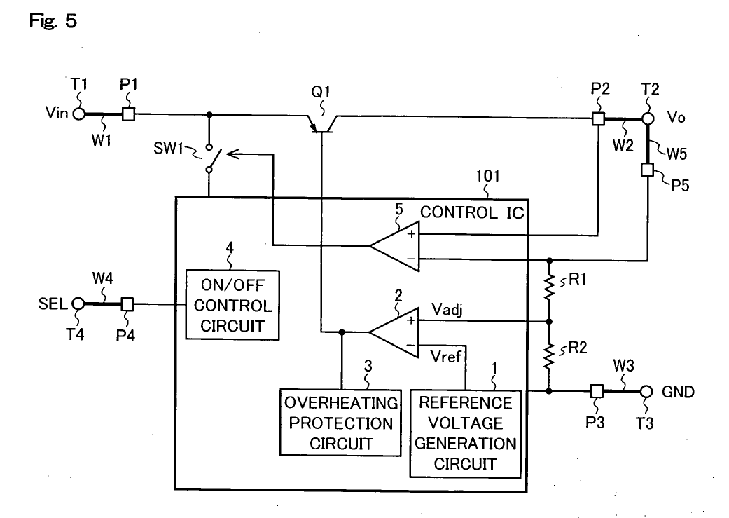

The above-described first and second embodiments deal with cases where overcurrent protection is performed by limiting the base current of the power transistor Q1 used as the output transistor. It is to be understood, however, that overcurrent protection may be performed by stopping the electric power supply to the control IC. For example, when the regulator shown in FIG. 1 is modified to the regulator that performs overcurrent protection by stopping the electric power supply to the control IC, this modified regulator has the configuration shown in FIG. 5.

The regulator shown in FIG. 5 is a version of the regulator shown in FIG. 1 modified by replacing the control IC 100 with a control IC 101 and additionally providing the electric power supply line to the control IC 101 with a switch SW1. The control IC 101 differs from the control IC 100 in that the output terminal of the comparator 5 is not connected to the base of the power transistor Q1, and that the switch SW1 is controlled by the output of the comparator 5.

The comparator 5, the connecting wire W2, and the switch SW1 are designed so that, when the difference in voltage across the connecting wire W2 becomes a value corresponding to an overcurrent, the switch SW1 is turned off by the output of the comparator 5 and the electric power supply to the control IC 101 is stopped. This makes it possible to perform overcurrent protection without providing an overcurrent detecting resistance. Furthermore, this provides a higher degree of accuracy in detecting an overcurrent compared to a method of detecting an overcurrent by monitoring the base current of the output transistor.

Alternatively, in the regulator shown in FIG. 5, the comparator 5, the connecting wire W2, and the switch SW1 may be designed so that an offset commensurate with the input voltage Vin inputted to the control IC 101 via the switch SW1 and the output voltage Vo inputted to the control IC 101 via the pad P5 is applied to the comparator 5, and, when the difference in voltage across the connecting wire W2 becomes substantially equal to a value obtained by subtracting the output voltage Vo from the input voltage Vin, the switch SW1 is turned off by the output of the comparator 5 and the electric power supply to the control IC 101 is stopped (the regulator configured as described above is referred to as a regulator according to a third embodiment of the present invention). Specifically, when the connecting wire W2 melts, a voltage at one end of the connecting wire W2 located on the side of the pad P2 becomes substantially equal to the input voltage Vin and a voltage at the other end of the connecting wire W2 located on the side of the leadframe terminal portion T2 becomes substantially equal to the output voltage Vo. Therefore, in the regulator according to the third embodiment of the present invention, when the connecting wire W2 melts, it is judged that an overcurrent occurs, and thus the electric power supply to the control IC 101 is stopped. The regulator according to the third embodiment of the present invention not only makes the connecting wire W2 serve as an equivalent of a fuse, but also adopts an overcurrent detecting method that detects an overcurrent by detecting whether or not the connecting wire W2 has melted.

In the regulator according to the third embodiment of the present invention, if the connecting wire W1 melts earlier than the connecting wire W2, the control IC 101 itself becomes inoperable. Therefore, it is preferable that the minimum fusing current of the connecting wire W2 be made smaller than the minimum fusing current of the connecting wire W1. The methods of making the minimum fusing current of the connecting wire W2 smaller than the minimum fusing current of the connecting wire W1 include a method of forming the connecting wires W1 and W2 of the same material and making the diameter of the connecting wire W2 smaller than the diameter of the connecting wire W1, and a method of forming the connecting wire W2 of a material having a higher electrical resistivity than that of the material of the connecting wire W1.

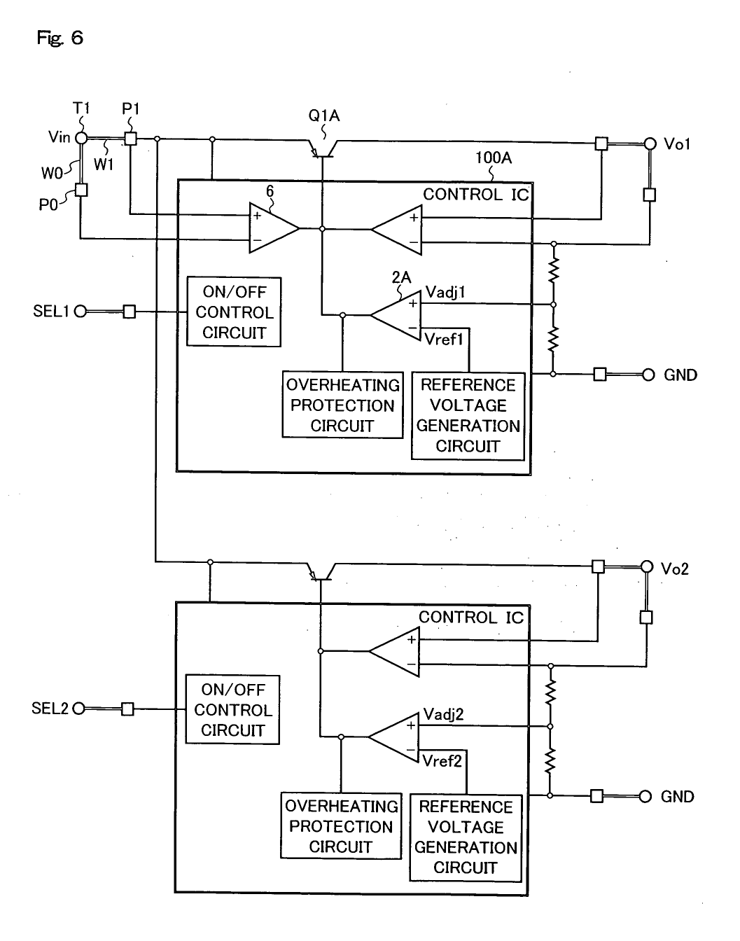

Next, a multiple output regulator of the present invention will be described. FIG. 6 shows an example of the configuration of the multiple output regulator of the present invention.

The multiple output regulator shown in FIG. 6 is configured as follows. Two regulators having the configuration shown in FIG. 1 are provided. In these two regulators, the leadframe terminal portion T1, the connecting wire W1, and the pad P1 are made common, and a pad P0 and a connecting wire W0 that electrically connects the pad P0 and the leadframe terminal portion T1 are additionally provided. In one of these regulators, there is further provided a comparator 6 inside an control IC 100A. The non-inverting input terminal of the comparator 6 is connected to the pad P1, the inverting input terminal thereof is connected to the pad P0, and the output terminal thereof is connected to the base of an output transistor Q1A of the one regulator. An error amplifier 2A, the comparator 6, and the connecting wire W1 are designed so that, when the difference in voltage across the connecting wire W1 becomes a value corresponding to an overcurrent, the output voltage of the comparator 6 becomes higher than the output voltage of the error amplifier 2A of the one regulator and the base current of the output transistor Q1A of the one regulator is limited.

The multiple output regulator shown in FIG. 6 can perform overcurrent protection not only for the current flowing toward the load for each output voltage line, but also for the current injected from the input power source into the multiple output regulator shown in FIG. 6. Incidentally, the number of voltage lines is increasing as the load voltage becomes lower due to the recent trend toward digitization. Since the regulator supplies the load with the load current until the load current reaches overcurrent, if in a plurality of lines the load currents are simultaneously close to overcurrent, the current injected from the input power source into the multiple output regulator becomes so large that the input power source is put under an excessive load. Therefore, the multiple output regulator shown in FIG. 6 that is capable of limiting the current injected from the input power source into the multiple output regulator is highly useful.

The above description deals with a multiple output regulator shown in FIG. 6 that performs overcurrent protection for the current flowing toward the load for each output voltage line by limiting the base current of the output transistor. It is to be understood, however, that overcurrent protection may be performed for the current flowing toward the load for each output voltage line by stopping the electric power supply to the control IC.

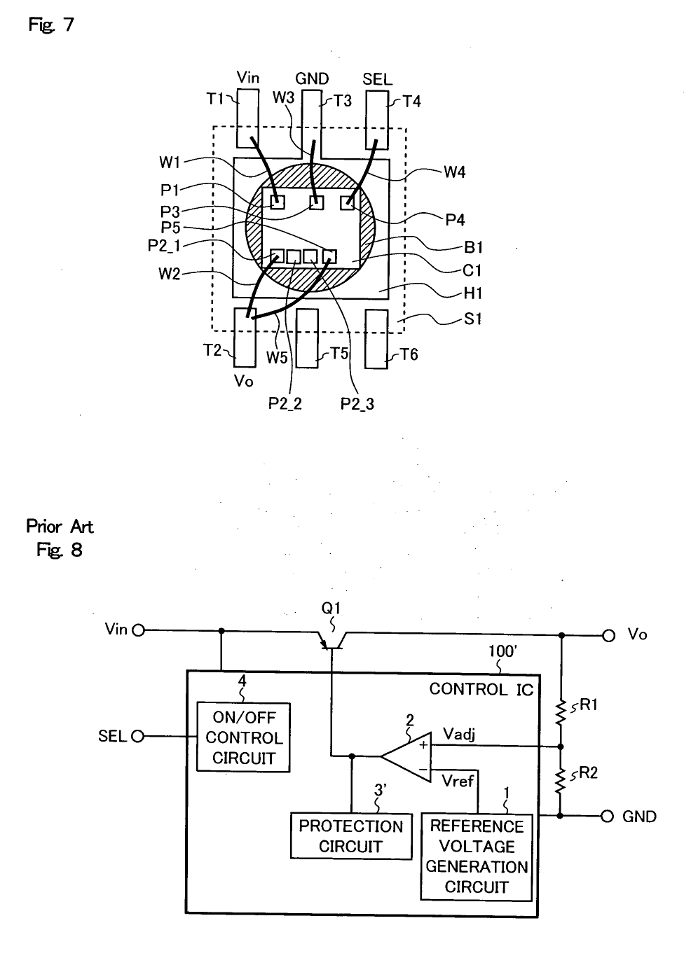

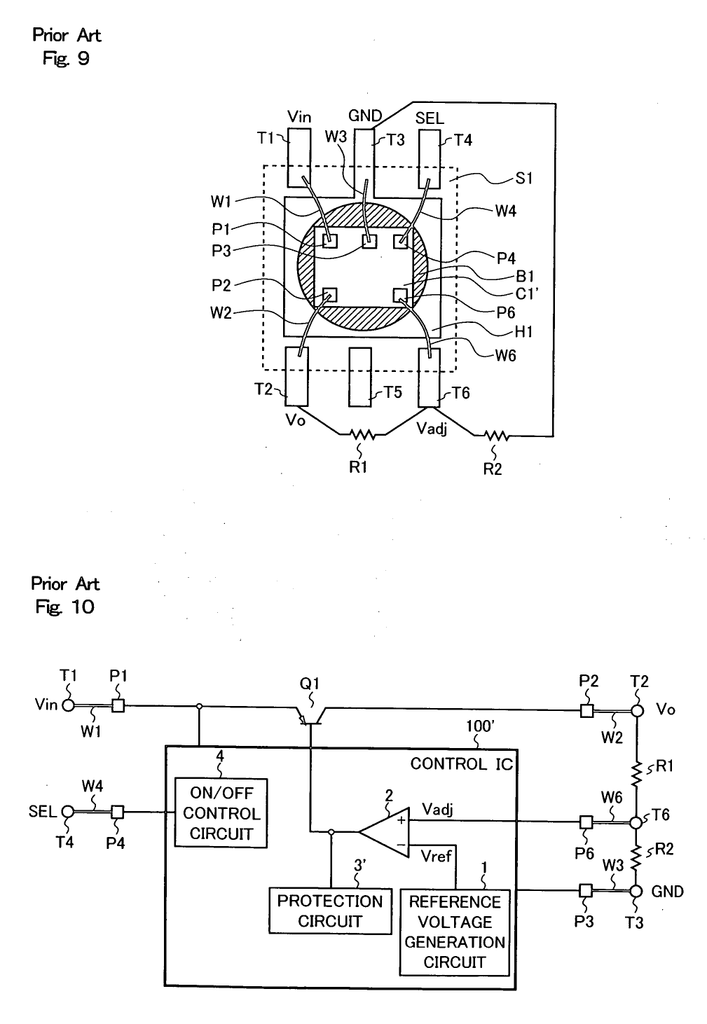

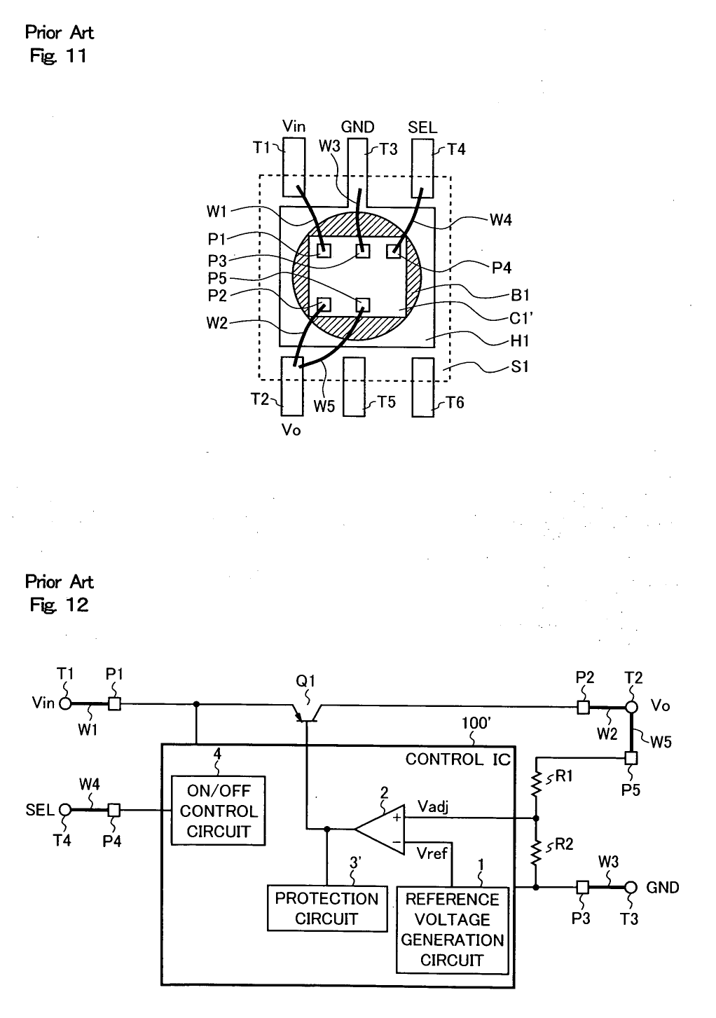

The above-described regulator according to the first embodiment of the present invention may be provided with a plurality of pads for current supply as shown in FIG. 7. FIG. 7 shows a state in which a pad P2_1 for current supply is selected. The length of the connecting wire W2 for current supply connected by wire bonding is previously determined for each of the pads P2_1 to P2_3 for current supply, and the resistance value of the connecting wire W2 for current supply is calculated for each of the pads P2_1 to P2_3 for current supply. Since the difference in voltage across the connecting wire W2 at which the comparator 5 starts to limit the base current of the power transistor Q1 is previously determined by the IC chip, it is possible to change an overcurrent detecting point by selecting a pad for current supply to which the connecting wire W2 is to be actually connected. This makes it possible to adjust an overcurrent detecting point of a product during assembly, even using the same IC chip. Alternatively, instead of changing the length of the connecting wire W2 for current supply by providing a plurality of pads for current supply as described above, it is possible to change an overcurrent detecting point by changing a material of the connecting wire W2 for current supply. This makes it possible to adjust an overcurrent detecting point of a product during assembly, even using the same IC chip. The materials of the connecting wire W2 include gold, copper, aluminum, or an alloy thereof. Such a method of adjusting an overcurrent detecting point can be applied not only to the regulator according to the first embodiment of the present invention, but also to the regulator of the present invention in general.

The above-described embodiments deal with series regulators using a bipolar transistor as the output transistor. It is to be understood, however, that the present invention can be applied to a series regulator or a switching regulator using a MOS transistor (for example, a CMOS transistor) as the output transistor. Furthermore, the above-described embodiments deal with series regulators provided with an IC chip having a built-in resistance for dividing the output voltage Vo. It is to be understood, however, that the present invention can be applied to a series regulator, although it needs to be provided with a sensing pad for sensing the output voltage Vo, that is provided with an IC chip having an externally-attached resistance for dividing the output voltage Vo.

1. A regulator comprising:
a leadframe;
an IC chip;
a wire for current supply;
an overcurrent detection portion that detects an overcurrent based on a difference in voltage across the wire for current supply,
wherein the leadframe is provided with a terminal portion for current supply that is part of a current supply line that supplies a load with current,
wherein the IC chip is provided with a pad for current supply that is part of the current supply line, and
wherein the wire for current supply is part of the current supply line and electrically connects the terminal portion for current supply and the pad for current supply.

2. A regulator comprising:
a leadframe;
an IC chip;
a wire for current injection;
an overcurrent detection portion that detects an overcurrent based on a difference in voltage across the wire for current injection,
wherein the leadframe is provided with a terminal portion for current injection that is part of a current injection line into which current is injected from an input power source,
wherein the IC chip is provided with a pad for current injection that is part of the current injection line, and
wherein the wire for current injection is part of the current injection line and electrically connects the terminal portion for current injection and the pad for current injection.

3. A regulator having a plurality of output lines, the regulator comprising:
a leadframe;
an IC chip;
wires for current supply provided one for each of the output lines;
a wire for current injection;
a first overcurrent detection portion provided one for each of at least one output line; and
a second overcurrent detection portion that detects an overcurrent based on a difference in voltage across the wire for current injection,
wherein the leadframe is provided with terminal portions for current supply one for each of the output lines, the terminal portion for current supply being part of a current supply line that supplies a load with current, and is provided with a terminal portion for current injection that is part of a current injection line into which current is injected from an input power source,
wherein the IC chip is provided with pads for current supply one for each of the output lines, the pad for current supply being part of the current supply line, and is provided with a pad for current injection that is part of the current injection line,
wherein the wire for current supply is part of the current supply line and electrically connects the terminal portion for current supply and the pad for current supply,
wherein the wire for current injection is part of the current injection line and electrically connects the terminal portion for current injection and the pad for current injection, and
wherein the first overcurrent detection portion detects an overcurrent based on a difference in voltage across the wire for current supply.

4. The regulator of claim 1, further comprising:
a voltage conversion portion that converts an input voltage to an output voltage; and
a control portion that controls the voltage conversion portion in accordance with the output voltage,
wherein overcurrent protection is performed by limiting, when an overcurrent is detected by the overcurrent detection portion, a control signal to be outputted from the control portion to the voltage conversion portion.

5. The regulator of claim 1, further comprising:
a voltage conversion portion that converts an input voltage to an output voltage; and
a control portion that controls the voltage conversion portion in accordance with the output voltage,
wherein overcurrent protection is performed by stopping, when an overcurrent is detected by the overcurrent detection portion, electric power supply to the control portion.

6. The regulator of claim 1,
wherein the overcurrent detection portion judges that an overcurrent occurs when a difference in voltage across the wire for current supply is substantially equal to a difference between input and output voltages of the regulator.

7. The regulator of claim 6,
wherein the leadframe is provided with a terminal portion for current injection that is part of a current injection line into which current is injected from an input power source,
wherein the IC chip is provided with a pad for current injection that is part of the current injection line,
wherein the regulator further comprises a wire for current injection that is part of the current injection line and electrically connects the terminal portion for current injection and the pad for current injection, and
wherein a minimum fusing current of the wire for current supply is smaller than a minimum fusing current of the wire for current injection.

8. The regulator of claim 2, further comprising:
a voltage conversion portion that converts an input voltage to an output voltage; and
a control portion that controls the voltage conversion portion in accordance with the output voltage,
wherein overcurrent protection is performed by limiting, when an overcurrent is detected by the overcurrent detection portion, a control signal to be outputted from the control portion to the voltage conversion portion.

9. The regulator of claim 2, further comprising:
a voltage conversion portion that converts an input voltage to an output voltage; and
a control portion that controls the voltage conversion portion in accordance with the output voltage,
wherein overcurrent protection is performed by stopping, when an overcurrent is detected by the overcurrent detection portion, electric power supply to the control portion.

10. A method of adjusting an overcurrent detecting point of the regulator of claim 1, the regulator having a plurality of the pads for current supply and/or a plurality of the pads for current injection,
wherein an overcurrent detecting point is adjusted by adjusting a length of the wire for current supply and/or the wire for current injection by selecting the pad for current supply and/or the pad for current injection.

11. A method of adjusting an overcurrent detecting point of the regulator of claim 1,
wherein an overcurrent detecting point is adjusted by selecting a material of the wire for current supply and/or the wire for current injection.

12. A method of adjusting an overcurrent detecting point of the regulator of claim 2, the regulator having a plurality of the pads for current supply and/or a plurality of the pads for current injection,
wherein an overcurrent detecting point is adjusted by adjusting a length of the wire for current supply and/or the wire for current injection by selecting the pad for current supply and/or the pad for current injection.

13. A method of adjusting an overcurrent detecting point of the regulator of claim 3, the regulator having a plurality of the pads for current supply and/or a plurality of the pads for current injection,
wherein an overcurrent detecting point is adjusted by adjusting a length of the wire for current supply and/or the wire for current injection by selecting the pad for current supply and/or the pad for current injection.

14. A method of adjusting an overcurrent detecting point of the regulator of claim 2,
wherein an overcurrent detecting point is adjusted by selecting a material of the wire for current supply and/or the wire for current injection.

15. A method of adjusting an overcurrent detecting point of the regulator of claim 3,
wherein an overcurrent point is adjusted by selecting a material of the wire for current supply and/or the wire for current injection.
